(19) United States
(12) Patent Application Publication
(10) Pub. No.: US 2025/0140074 A1
(43) Pub. Date: May 1, 2025

(54) METHODS, SYSTEMS, AND APPARATUSES FOR GENERATING POOL COMPETITIONS

(71) Applicant: Underdog Sports, Inc., Brooklyn, NY (US)

(72) Inventors: Brandon Stakenborg, Brooklyn, NY (US); Guy Lake, Brooklyn, NY (US); Weston Jossey, Brooklyn, NY (US); Nicholas Green, Brooklyn, NY (US); Jeremy Levine, Brooklyn, NY (US)

(21) Appl. No.: 18/931,235

(22) Filed: Oct. 30, 2024

Related U.S. Application Data
(60) Provisional application No. 63/594,178, filed on Oct. 30, 2023.

(51) Int. Cl. G07F 17/32

(52) U.S. Cl. CPC G07F 17/3288; G07F 17/3244

(57) ABSTRACT

Methods, apparatuses, and systems are described for generating pool competitions. A user may select a price and a pick count for a pool competition. For the selected pick count, the user may select a prediction for each event of an amount of events according to the pick count. Each event may include a predicted outcome associated with a player statistic associated with a sports event. The user may be associated with a group of users that corresponds to the selected price and pick count. After each event concludes, a total number of correct predictions per user of the group of users may be determined. Based on the total number of correct predictions for each user of the group of users satisfying a condition, an award may be provided to one or more users of the group of users.

### CROSS-REFERENCE TO RELATED APPLICATION

This application claims the priority benefit of U.S. Provisional Application No. 63/594,178, filed Oct. 30, 2023, the entirety of which is incorporated herein by reference.

### BACKGROUND

Fantasy sports contests, such as pickem competitions, have steadily increased in recent years. Conventional pickem competitions typically involve competitions in which users predict outcomes of one or more games over a predefined period of time, accumulating points for correct predictions. These competitions involve a player versus house competitions. However, since these conventional pickem competitions do not include any type of tournament-style competition, they are not accessible from every location.

### SUMMARY

It is to be understood that both the following general description and the following detailed description are exemplary and explanatory only and are not restrictive.

Methods, systems, and apparatuses for generating pool competitions. A user may select a price and a pick count for a pool competition. For the selected pick count, the user may select a prediction for each event of an amount of events according to the pick count. Each event may include a predicted outcome associated with a player statistic associated with a sports event. The user may be associated with a group of users that corresponds to the selected price and pick count. After each event concludes, a total number of correct predictions per user of the group of users may be determined. Based on the total number of correct predictions for each user of the group of users satisfying a condition, an award may be provided to one or more users of the group of users.

In an embodiment, are methods comprising determining, by a computing device, a plurality of events for one or more gaming sessions, receiving, from each user device of a plurality of user devices, a selection of a price and a selection of an amount of events of the plurality of events, wherein each user device is associated with a user, receiving, from each user device, a prediction associated with the each event of the plurality of events of the corresponding selected amount of events, associating each user with a group of users for each gaming session of the one or more gaming sessions according to the corresponding selected price received from each user device and the corresponding selected amount of events received from each user device, determining one or more users of each group of users associated with an amount of correct predictions of the corresponding predictions associated with each user that satisfies a condition, determining, based on the satisfied condition, one or more awards corresponding to the one or more users, and sending a notification of each award to each user of the one or more users.

In an embodiment, are methods comprising determining, by a computing device, a plurality of events for a gaming session, receiving, from a user device associated with a user, a selection of a price and a selection of an amount of events of the plurality of events, receiving a prediction associated with each event of the selected amount of events, associating, based on the selected price and the selected amount of events, the user with a group of users for the gaming session, determining, based on an amount of correct predictions of the predictions associated with the selected amount of events satisfying a condition, an award, and sending a notification of the award to the user.

In an embodiment, are methods comprising determining, by a user device, a plurality of events for a gaming session, outputting a first user interface configured to display one or more options associated with the gaming session to a user of the user device, wherein the one or more options comprise one or more of one or more prices or one or more amount of events of the plurality of events, causing, based on a selection of a price of the one or more prices and based on a selection of an amount of events of the one or more amount of events, output of a second user interface configured to display an option for receiving input of a prediction for each event of the plurality of events associated with the amount of events, associating the user with a group of users for the gaming session associated with the selected price and the selected amount of events, causing, based on an input of a prediction for each event of the amount of events, output of a third user interface configured to display results associated with each prediction associated with the group of users, and updating, based on a number of correct predictions of the selected amount of events, the results.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of the present description serve to explain the principles of the apparatuses and systems described herein:

FIG. 1 shows an example system;

FIGS. 2A-2B show a flowchart of an example method;

FIGS. 3A-3B show a flowchart of an example method;

FIG. 4 shows an example user interface;

FIG. 5 shows an example user interface;

FIG. 6 shows an example user interface;

FIG. 7 shows an example user interface;

FIG. 8 shows a flowchart of an example method;

FIG. 9 shows a flowchart of an example method; and

FIG. 10 shows a flowchart of an example method.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

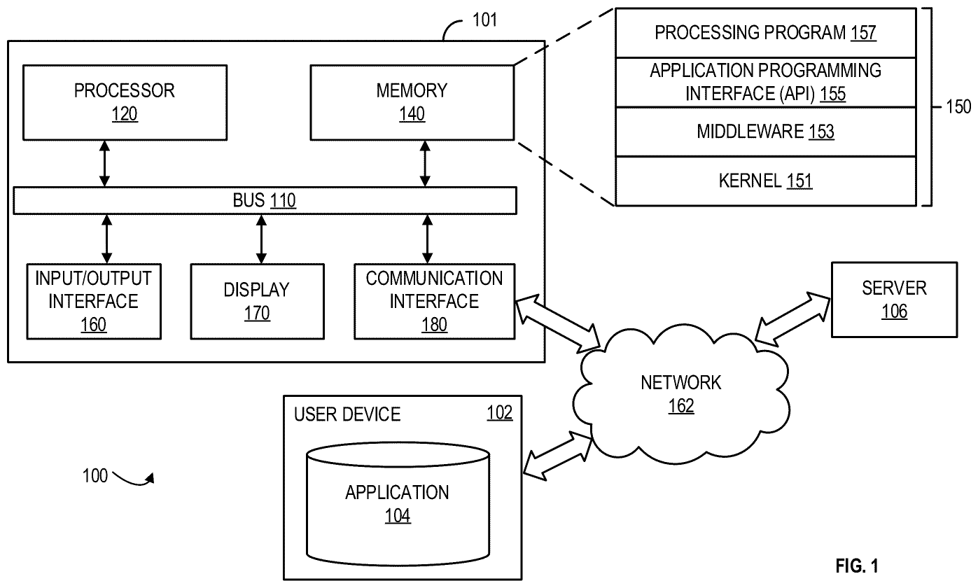

FIG. 1 shows an example system 100 for generating pool competitions (e.g., gaming sessions). A plurality of events for a pool competition may be determined. Each event of the plurality of events may comprise a predicted outcome associated with a player statistic associated with a sports event. A user may select a price (e.g., entry fee) and pick count (e.g., amount of events) for a pool competition. Based on the selected pick count, the user may select a prediction for each event of an amount of events according to the pick count. The user may be associated with a group of users that corresponds to the selected price and pick count. After each event associated with the pool competition concludes, a total number of correct predictions per user of the group of users may be determined. Based on the total number of correct predictions for each user of the group of users satisfying a condition, an award may be determined for one or more users (e.g., winning user(s)) of the group of users. The system 100 may include a backend platform device 101, one or more user devices 102, and one or more external servers 106. In an example, the backend platform device 101 may be configured to receive user inputs and generate one or more gaming sessions (e.g., pool competitions) based on the user inputs. In an example, the backend platform device 101 may be in communication with the user devices 102, and the one or more external servers 106 via a network (e.g., network 162).

The backend platform device 101 may include a bus 110, one or more processors 120, a memory 140, an input/output interface 160, a display 170, and a communication interface 180. In certain examples, the backend platform device 101 may omit at least one of the aforementioned elements or may additionally include other elements. The backend platform device 101 may comprise, for example, a host server capable of processing the user inputs in order to generate the gaming sessions.

The bus 110 may comprise a circuit for connecting the bus 110, the one or more processors 120, the memory 140, the input/output interface 160, the display 170, and/or the communication interface 180 to each other and for delivering communication (e.g., a control message and/or data) between the bus 110, the one or more processors 120, the memory 140, the input/output interface 160, the display 170, and/or the communication interface 180.

The one or more processors 120 may include one or more of a Central Processing Unit (CPU), an Application Processor (AP), or a Communication Processor (CP). The one or more processors 120 may control, for example, at least one of the bus 110, the memory 140, the input/output interface 160, the display 170, and/or the communication interface 180 of the backend platform device 101 and/or may execute an arithmetic operation or data processing for communication. As an example, the one or more processors 120 may cause the backend platform device 101 to process the user input via a processing program 157 in order to generate the gaming sessions. The processing (or controlling) operation of the one or more processors 120 according to various embodiments is described in detail with reference to the following drawings.

The processor-executable instructions executed by the one or more processors 120 may be stored and/or maintained by the memory 140. The memory 140 may include a volatile and/or non-volatile memory. The memory 140 may include random-access memory (RAM), flash memory, solid state or inertial disks, or any combination thereof. As an example, the memory 140 may include an Embedded MultiMedia Card (eMMC). The memory 140 may store, for example, a command or data related to at least one of the bus 110, the one or more processors 120, the memory 140, the input/output interface 160, the display 170, and/or the communication interface 180 of the backend platform device 101. According to various examples, the memory 140 may store software and/or a program 150 or may comprise firmware. For example, the program 150 may include a kernel 151, a middleware 153, an Application Programming Interface (API) 155, a processing program 157, and/or the like, configured for controlling one or more functions of the backend platform device 101 and/or an external device (e.g., the one or more servers 106). At least one part of the kernel 151, middleware 153, or API 155 may be referred to as an Operating System (OS). The memory 140 may include a computer-readable recording medium (e.g., a non-transitory computer-readable medium) having a program recorded therein to perform the methods according to various embodiments by the one or more processors 120. In an example, the memory 140 may store the customized content.

The kernel 151 may control or manage, for example, system resources (e.g., the bus 110, the one or more processors 120, the memory 140, etc.) used to execute an operation or function implemented in other programs (e.g., the middleware 153, the API 155, or the input processing program 157). Further, the kernel 151 may provide an interface capable of controlling or managing the system resources by accessing individual elements of the data capture device 101 in the middleware 153, the API 155, or the input processing program 157.

The middleware 153 may perform, for example, a mediation role, so that the API 155, and/or the input processing program 157 can communicate with the kernel 151 to exchange data. Further, the middleware 153 may handle one or more task requests received from the input processing program 157 according to a priority. For example, the middleware 153 may assign a priority of using the system resources (e.g., the bus 110, the one or more processors 120, or the memory 140) of the backend platform device 101 to at least one of the input processing program 157. For example, the middleware 153 may process the one or more task requests according to the priority assigned to at least one of the application programs, and thus, may perform scheduling or load balancing on the one or more task requests.

The API 155 may include at least one interface or function (e.g., instruction), for example, for file control, window control, video processing, and/or character control, as an interface capable of controlling a function provided by the input processing program 157 in the kernel 151 or the middleware 153.

The input processing program 157 may include logic (e.g., hardware, software, firmware, etc.) that may be implemented (e.g., executed by the one or more processors 120) to process the user inputs received from one or more users, such as via the one or more user devices 102. The user devices 102 may comprise a laptop computer, a mobile phone, a smart phone, a tablet computer, a wearable device, a smartwatch, a desktop computer, a smart television, and the like. Each user device may be associated with a user. The user devices 102 may be configured to include an application 104 for providing the user inputs. In an example, the application 104 may comprise a mobile application or a web browser. Each user device 102 may execute the application 104, wherein the application 104 may cause the user devices 102 to output a user interface that may include one or more options associated with a gaming session (e.g., pool competition). The input processing program 157 may be implemented to cause the backend platform device 101 to determine a plurality of events for the gaming session. Each event of the plurality of events may comprise a predicted outcome associated with a player statistic associated with a sports event (e.g., a sports game such as a basketball game, a baseball game, a football game, a hockey game, etc.). The one or more options may comprise one or more prices (e.g., entry fee, pick price, etc.) and one or more amount of events (e.g., pick counts) associated with the plurality of events. Each user of each user device may select a price and an amount of events. For example, a user may select from a list of prices such as $5, $20, $50, and $100 and from a list of pick counts such as Pick 2, Pick 3, Pick 4, and Pick 5. The backend platform device 101 may associate each user with a group of users for each gaming session. For example, each group of users may comprise a plurality of users associated with a designated price and a designated amount of events. For example, if the user selected a pick price of $20 and a pick count of Pick 5, the user would be associated with (e.g., placed in) a group of users that also selected the pick price of $20 and the pick count of Pick 5. Each event of the plurality of events may be associated with a time duration for settling. For example, since each event comprises player statistics during a sports event, the final statistics for the player would not finalize until the end of the sports event. Thus, each user would not be placed into a group of users until every event for that user settles. For example, if a user selected a pick count of Pick 5 and a pick price of $20 the user would not be placed into a group associated with a Pick 5 pick count and $20 pick price until every event associated with the user's selection/entry finalized (e.g., the associated sports event is completed or ends). For example, the user would be placed in the group when the final statistics for each event associated with the user finalizes/settles after the end of the longest duration of the events associated with that user. Each user may provide a prediction associated with each event of the plurality of events up to the selected amount of events (e.g., 5 predictions for Pick 5, 4 predictions for Pick 4, etc.). For example, each user may select the initial predicted outcome of each event or provide an alternative prediction (e.g., higher or lower than the initial predicted outcome) for each event. For example, a user that selected Pick 2 may provide a first prediction associated with a first player associated with a first sports event and provide a second prediction associated with a second player associated with a second sports event. Once the events (e.g., statistics) finalize (e.g., each game ends), the backend platform device 101 may determine an amount of correct predictions by each user of each group of users. The backend platform device 101 may determine one or more users of each group of users associated with an amount of correct predictions that satisfies a condition. The condition may comprise one or more of a determination that all predictions received from a user are correct, or a determination that at least one prediction received from a user is correct and no other user in the corresponding group of users associated with the user has a number of predictions greater than the user. The backend platform device 101 may determine one or more awards corresponding to the one or more users based on the satisfied condition. For example, the one or more awards may comprise one of a first award based on a determination that all predictions received from a user of a group of users are correct, or a second award based on a determination that at least one prediction received from a user of a group of users is correct and no other user in the corresponding group of users associated with the user has a number of predictions greater than the user. The backend platform device 101 may send a notification of each award to each user of the one or more users. The notification may comprise one or more of a text message, a push notification, or an email message. In addition, the backend platform device 101 may send each award to each user of the one or more users.

In an example, the backend platform device 101 may determine one or more of the users that are associated with a selection of one or more of a push, a tic, or a void. Each of the users may be associated with a group of users for each gaming session based on the selection of a push, a tic, or a void. For example, if a user's entry contains a push, a tie, or a void, the user may be added to a gaming session with a pick count (e.g., amount of events) equal to the user's initial pick count minus the number of pushes, ties, or voids for the same pick price. For example, a user may have initially selected an amount of events (or a pick count) of 5 events and a pick price of $10. The user would have been placed in a group of users for a gaming session (e.g., pool competition) with other users that selected a pick count of 5 events and a pick price of $10. However, if the user made a further selection associated with a push, a tie, or a void, the user would be placed in a group of users that selected a pick count of 4 events and a pick price of $10.

In example, each group of users for each gaming session may comprise a predetermined amount of users (e.g., 10, 20, 50, 80, 100, etc.). For example, each group of users may be filled with new users that selected the same price and pick count until reaching the predetermined amount of users for that group of users. Afterwards, a new group of users for that price and pick count may be created and new users may be added to the new group of users until it reaches the predetermined amount of users. For example, if a pick 5, $5 group of users has a maximum amount of users of 100, users that selected a pick count of 5 and a pick price of $5will be added to the group of users until it reaches 100 users. Afterwards, a new pick 5, $5 group of users may be created and new users that selected a pick count of 5 and a pick price of $5 will be added to the new group of users.

As an example, the awards may be further determined based on the pick price, the pick count, the amount of correct predictions, and/or the amount of users associated with the group of users. In an example, an award may be determined for providing predictions that are all correct. In another example, an award may be determined for providing the most correct predictions. For example, in a pick 5, $10 gaming session, a user may have provided three correct predictions. If no other user in the user's group of users for the gaming session provided a higher amount of correct predictions, the user may win an award based on the payout for a pick 5, price $10 gaming session.

The applications 104 of the user devices 102 may be configured to provide one or more user interfaces for receiving user inputs associated with the gaming sessions and to display results of the gaming sessions. For example, the application 104 may output a first user interface configured to display the one or more options comprising the one or more prices and the one or more amount of events. In an example, the first user interface may be output based on a location of the user device 102. A user may provide a user input via the first user interface comprising a selection of a price of the one or more prices and a selection of an amount of events of the one or more amount of events. Based on the user input selections, the application 104 may output a second user interface configured to display an option for receiving input of the predictions for each event of the plurality of events up to the selected amount of events. Based on the user input predictions, the application 104 may output a third user interface configured to display results associated with each prediction associated with each corresponding group of users. The results (e.g., display of the results) may be updated based the number of correct predictions of the selected amount of events. For example, the results may be updated based on the number of correct predictions satisfying a condition. The condition may comprise one of no correct predictions of the selected amount of events, all of the predictions are correct and all user entries of the group of users are final, all of the predictions are correct and all user entries of the group of users are not final, or at least one prediction is correct and no other user in the group of users has a greater number of correct predictions. In an example, based on the condition of no correct predictions of the selected amount of events, the updated results may comprise one or more of an indication of a loss, each correct prediction of the selected amount of events, or each incorrect prediction of the selected amount of events. In another example, based on the condition of all of the predictions are correct and all user entries of the group of users are final, the updated results may comprise one or more of predictions associated with each user of the group of users, an award amount, a portion of the award amount associated with the user, an amount of users of the group of users with all correct predictions, or one or more names of experienced users of the group of users. In another example, based on the condition of all of the predictions are correct and all user entries of the group of users are not final, the results updated may comprise one or more of predictions associated with each user of the group of users, an award amount associated with a winner of the group of users, an amount of users of the group of users with all correct predictions, an award amount associated with all correct predictions, or a pending state associated with a potential portion of the award amount associated with the user. In another example, based on the condition of at least one prediction is correct and no other user in the group of users has a greater number of correct predictions, the updated results may comprise one or more of an amount of correct predictions, an award amount.

The input/output interface 160 may include an interface for delivering an instruction or data input from a user (e.g., an operator of the backend platform device 101) or from a different external device (e.g., user device 102 or servers 106) to the different elements of the backend platform device 101. The input/output interface 160 may further include an interface for outputting one or more user interfaces to the user. For example, the input/output interface 160 may comprise a display, such as a touch screen display, and/or one or more physical input interfaces (e.g., keyboard, mouse, etc.) configured to receive user inputs. Further, the input/output interface 160 may output an instruction or data received from one or more elements of the backend platform device 101 to one or more external devices (e.g., user device 102 or servers 106).

The display 170 may include various types of displays, for example, a Liquid Crystal Display (LCD) display, a Light Emitting Diode (LED) display, an Organic Light-Emitting Diode (OLED) display, a MicroElectroMechanical Systems (MEMS) display, or an electronic paper display. The display 170 may display, for example, a variety of contents (e.g., text, image, video, icon, symbol, etc.) to the user. The display 170 may include a touch screen. The input processing program 157 may cause the display 170 to output an interface displaying the user selections (e.g., pick prices and/or pick counts) associated with one or more gaming sessions (e.g., pool competitions) and results associate with each gaming session.

The communication interface 180 may establish, for example, communication between the data capture device 101 and one or more external devices (e.g., the display device 102, the electronic device 104, and/or the server 106). For example, the communication interface 180 may communicate with the one or more external devices (e.g., the user device 102 and/or the servers 106) by being connected to a network 162 through wireless communication or wired communication. The network 162 may include, for example, at least one of a telecommunications network, a computer network (e.g., LAN or WAN), the Internet, and/or a telephone network.

The communication interface 180 may be configured to communicate with the one or more external devices (e.g., user device 102 or server 106) via the network 162 (e.g., Internet, LAN, etc.). In an example, the communication interface 180 may be configured to access the network 162 via a wireless communication interface such as a cellular communication protocol. The cellular communication protocol may comprise at least one of Long-Term Evolution (LTE), LTE Advance (LTE-A), Code Division Multiple Access (CDMA), Wideband CDMA (WCDMA), Universal Mobile Telecommunications System (UMTS), Wireless Broadband (WiBro), Global System for Mobile Communications (GSM), and the like. In an example, the wireless communication interface may be configured to use a near-distance communication. The near-distance communication interface may include for example, at least one of Wireless Fidelity (WiFi), Bluetooth, Bluetooth Low Energy (BLE), Near Field Communication (NFC), Global Navigation Satellite System (GNSS), and the like. According to a usage region or a bandwidth or the like, the GNSS may include, for example, at least one of Global Positioning System (GPS), Global Navigation Satellite System (GLONASS), BeiDou Navigation Satellite System (BDS), Galileo, the European global satellite-based navigation system, and the like. Hereinafter, the “GPS” and the “GNSS” may be used interchangeably in the present document.

The external servers 106 may include a group of one or more external servers. For example, all or some of the operations executed by the backend platform device 101 and/or the user devices 102 may be executed in a different server or a plurality of external servers 106. For example, a cloud computing, distributed computing, or client-server computing technique may be used. As an example, the backend platform device 101, one or more of the user device 102, and/or the external servers 106 may be configured as a distributed computing system that applies networked computing technology to support the implementation of the gaming sessions. In an example, if the backend platform device 101, one or more of the user device 102, and/or the external servers 106 needs to perform a one or more functions or services either automatically or based on a request, the backend platform device 101, one or more of the user device 102, and/or the external servers 106 may request at least some parts of the functions related thereto alternatively or additionally to a different server 106 or plurality of external servers 106 instead of executing one or more of the functions or the services autonomously. In an example, different parts of the functions or the services may be distributed amongst the backend platform device 101, one or more of the user device 102, and/or the external servers 106. For example, the different parts of the functions or the services may be implemented by a combination of the backend platform device 101, one or more of the user device 102, and/or the external servers 106. One or more of the external servers 106 and/or one or more of the user devices 102 may execute the requested function or additional function, and may deliver a result thereof to the backend platform device 101. The backend platform device 101 and/or one or more of the user devices 102 may provide the requested function or service either directly or by additionally processing the received result.

In an example, the backend platform device 101 and/or the external servers 106 may include one or more databases. For example, the databases may be used to store a plurality of user profiles associated with a plurality of users of the user devices 102. For example, the users may login (e.g., via the application 104) before starting a gaming session. The user profiles may comprise information associated with the users that may be used to determine one or more preferences associated with the users such as most frequent pick price(s), most frequent pick count(s), favorite player(s), favorite team(s), and/or favorite sport(s). In addition, the user profiles may be used to output important/relevant statistics associated with one or more of a user's favorite player(s), team(s), and/or sport(s). In an example, the database may store a plurality of statistical data and reference sources. A statistic may have an associated reference source indicating an origin of the at least one statistic, for example.

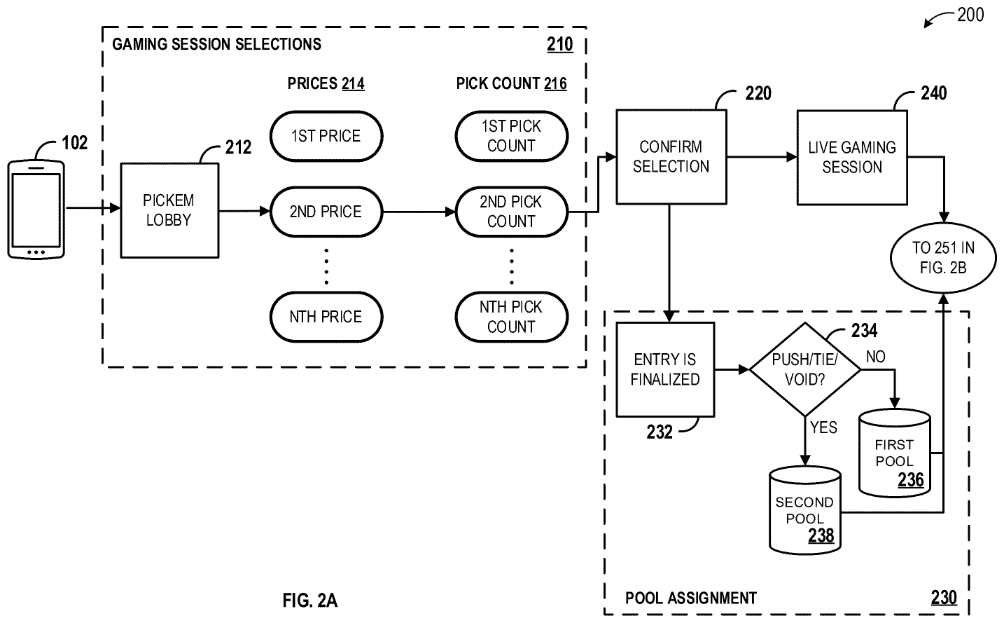

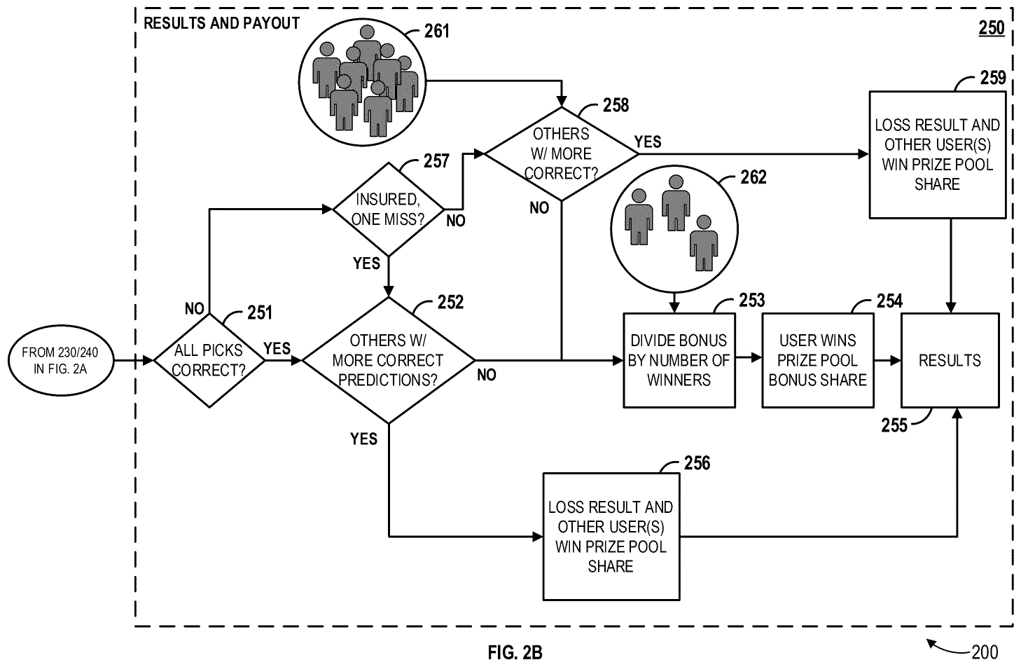

FIGS. 2A-2B show a flowchart of an example method 200 for generating a gaming session (e.g., pool competition). A user of the user device 102 (e.g., via the application 104) may provide selections for the gaming session at 210. At 212, a first user interface (e.g., a lobby) may be output via the user device 102. The first user interface may be configured to display one or more price (e.g., entry fee) options 214, such as $5, $20, and $50, and one or more amount of events (e.g., pick counts) options 216, such as Pick 2, Pick 4, and Pick 5. For example, the user may select a price of $40 and an amount (e.g., Pick Count) of 4 events. At 220, the user may confirm the selections.

Based on the selections, the user may be associated with, or placed, in a group of users for a gaming session at 230. At 232, the selections may be finalized. For example, the user may provide predictions of one or more events of a plurality of events for the gaming session. Each event of the plurality of events may comprise a predicted outcome associated with a player statistic of a sports event (e.g., basketball, baseball, football, etc.). The user may select the initial predicted outcome of each event up to the selected amount of events or provide an alternative prediction (e.g., higher or lower than the initial predicted outcome) for each event up to the selected amount of events. For example, the user may provide five predictions based on a selection of 5 events (e.g., pick 5). For example, the user may provide a first prediction for a first player associated with a first sports event, a second prediction for a second player associated with a second sports event, a third prediction for a third player associated with a third sports event, a fourth prediction for a fourth player associated with a fourth sports event, and a fifth prediction for a fifth player associated with a fifth sports event. The user may be associated with a group of users for the gaming session based on a time duration associated with each event for settling. For example, each user would not be grouped into a group of users until every event for that user settles. For example, if a user selected a pick count of Pick 5 and a pick price of $20 the user would not be placed into a group associated with a Pick 5 pick count and $20 pick price until every event associated with the user's selection/entry finalized (e.g., the associated sports event is completed or ends). For example, the user would be placed in the group when the final statistics for each event associated with the user finalizes/settles after the end of the longest duration of the events associated with that user. At 234, it may be determined whether one of the selections is associated with a push, a tic, or a void. If none of the selections is associated with a push, tic, or void, the user may be added to a group of users that selected the same price and amount of events at 236. If at least one of the selections is associated with a push, tic or void, the user may be added to a group of users that selected the same price but an amount of events minus an amount of pushes, ties, and/or voids of the user's selections at 238. At 240, the user may view the results (e.g., in real-time or live results) as the games are played out.

At 250, the results and payouts may be determined. At 251, after every event of the gaming session finalizes (e.g., the sports events conclude), it may be determined whether all of the user's predictions were correct. If the user's predictions were all correct, the YES branch may be followed to 252. At 252, it may be determined whether other users of the user's group of users had a greater amount of correct predictions than the user. In an example, a user may have selected Pick 5 for a gaming session. However, one of the user's selections may have been associated with a push, tic, or void and the rest of the user's selections may have been associated with correct predictions. Thus, the user would have been added to a group of users associated with a Pick 4 gaming session. If no other users had a greater amount of correct predictions than the user, the NO branch may be followed to 253. At 253, the award determined for the user may be divided by the amount of other users 262 that provided the same amount of correct predictions as the user. At 254, the user may also win a bonus share associated with the group of users. The result may be added to the overall final results at 255. Returning to 252, if other users had more correct predictions than the user, the YES branch may be followed to 256. At 256, it may be determined that the user loss the gaming session and the other users may win the prize pool share. The result may be added to the overall final results at 256.

Returning to 251, if at least one of the user's predictions was incorrect, the NO branch may be followed to 257. At 257, it may be determined whether the user had insurance associated with at least one miss, or incorrect prediction. If the user had insurance associated with at least one miss, the YES branch may be followed to 252. Otherwise, if the user did not have insurance associated with at least one miss, the NO branch may be followed to 258. At 258, it may be determined whether other users 261 of the user's group of users had more correct predictions than the user. For example, the user may have selected Pick 5 for a gaming session. However, only 3 predictions of the 5 predictions made by the user were correct. If another user of the user's group of users had a greater amount (e.g., 4 predictions) of correct predictions, the YES branch may be followed to 259. At 259, it may be determined that the user loss the gaming session. The result may be added to the overall final results at 255. Returning back to 258, if no other users in the user's group of users had a greater amount of correct predictions, the NO branch may be followed to 253. At 253, the award determined for the user may be divided by the amount of other users 262 that provided the same amount of correct predictions as the user. At 254, the user may also win a bonus share associated with the group of users. The result may be added to the overall final results at 255.

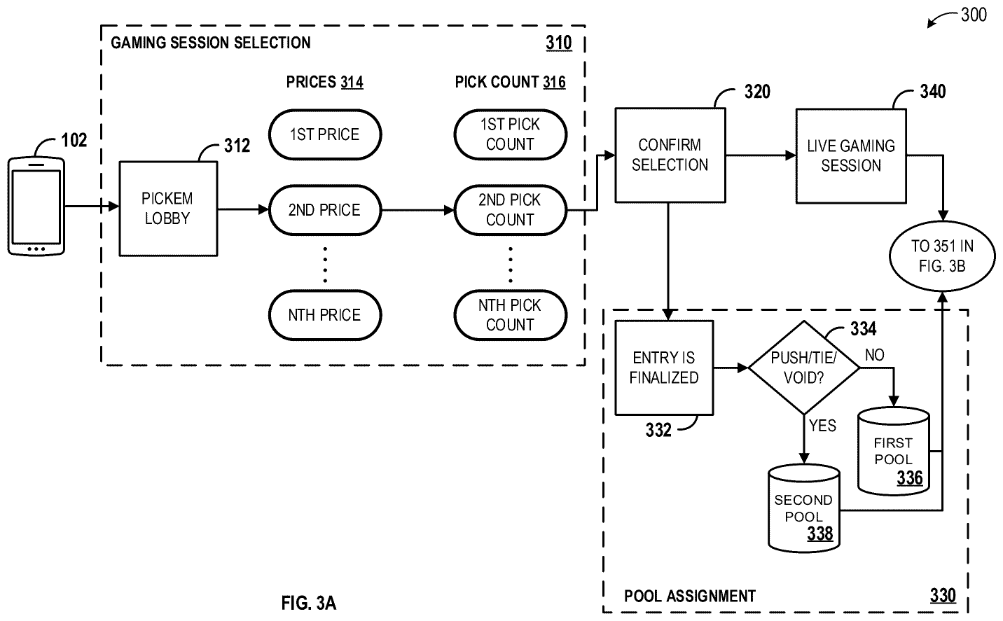

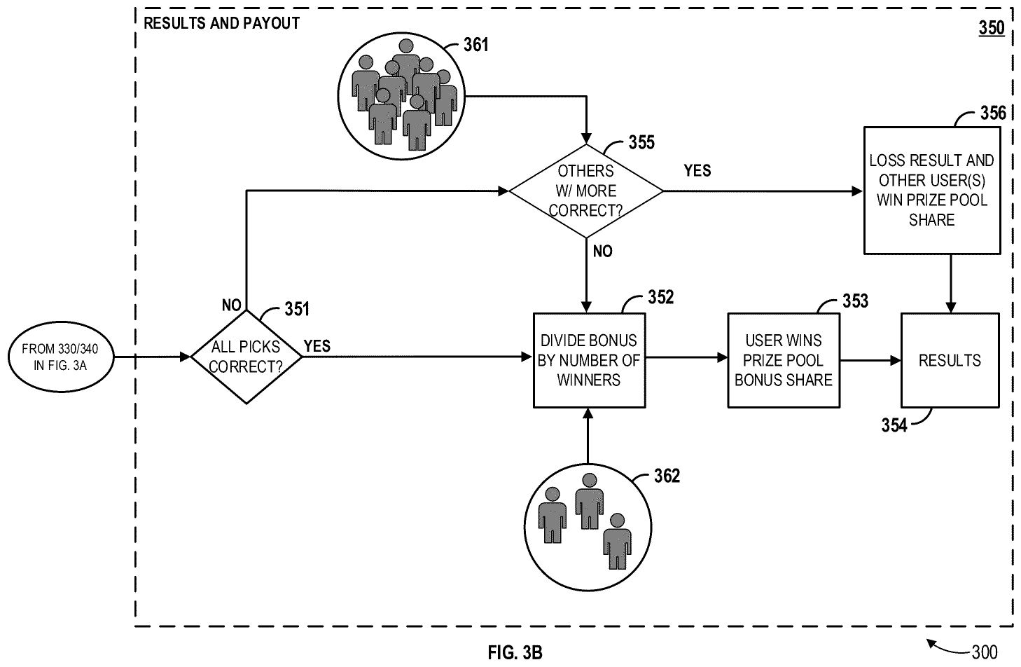

FIGS. 3A-3B show a flowchart of an example method 300 for generating a gaming session (e.g., pool competition) wherein insurance is not involved/allowed. The steps associated with 210, 220, 230, and 240 shown in FIG. 2A are similar to the steps associated with 310, 320, 330, and 340 shown in FIG. 3A. At 351, if it is determined that all of the user's predictions are correct, the YES branch may be followed to 352. At 352, the award determined for the user may be divided by the amount of other users 362 that provided the same amount of correct predictions as the user. At 353, the user may also win a bonus share associated with the group of users. The result may be added to the overall final results at 354.

Returning back to 351, if at least one of the user's predictions was incorrect, the NO branch may be followed to 355. At 355, it may be determined whether other users 361 of the user's group of users had more correct predictions than the user. For example, the user may have selected Pick 4 for a gaming session. However, only 2 predictions of the 4 predictions made by the user were correct. If another user of the user's group of users had a greater amount (e.g., 3 predictions) of correct predictions, the YES branch may be followed to 356. At 356, it may be determined that the user loss the gaming session. The result may be added to the overall final results at 354. Returning back to 355, if no other users in the user's group of users had a greater amount of correct predictions, the NO branch may be followed to 352. At 352, the award determined for the user may be divided by the amount of other users 362 that provided the same amount of correct predictions as the user. At 353, the user may also win a bonus share associated with the group of users. The result may be added to the overall final results at 355.

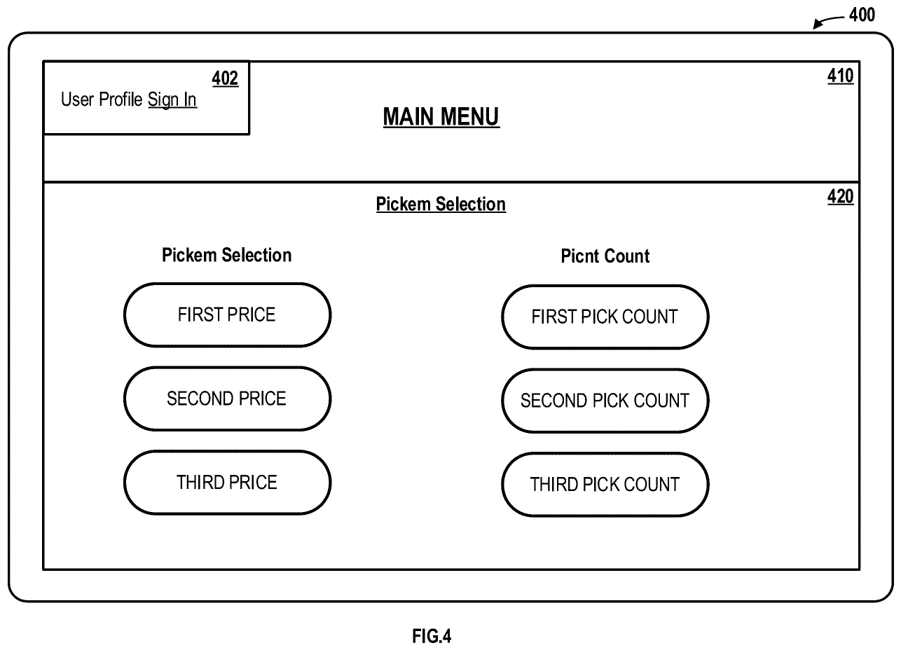

FIG. 4 shows an example user interface 400 that may be output when a user accesses the application 104 via the user device 102. The application 104 may comprise a mobile application or a web browser. The user interface 400 may comprise at least a main menu 410 (e.g., lobby area) wherein the user may be provided an option to log-in 402 to a user profile. In addition the application 104 may output options for initiating a gaming session (e.g., pool competition). For example, the user may select from one or more price (e.g., pick price, entry fee) options, such as $5, $20, $50, and $100, and one or more pick count (e.g., amount of events) options, such as Pick 2, Pick 3, Pick 4, and Pick 5, from the selection menu 420.

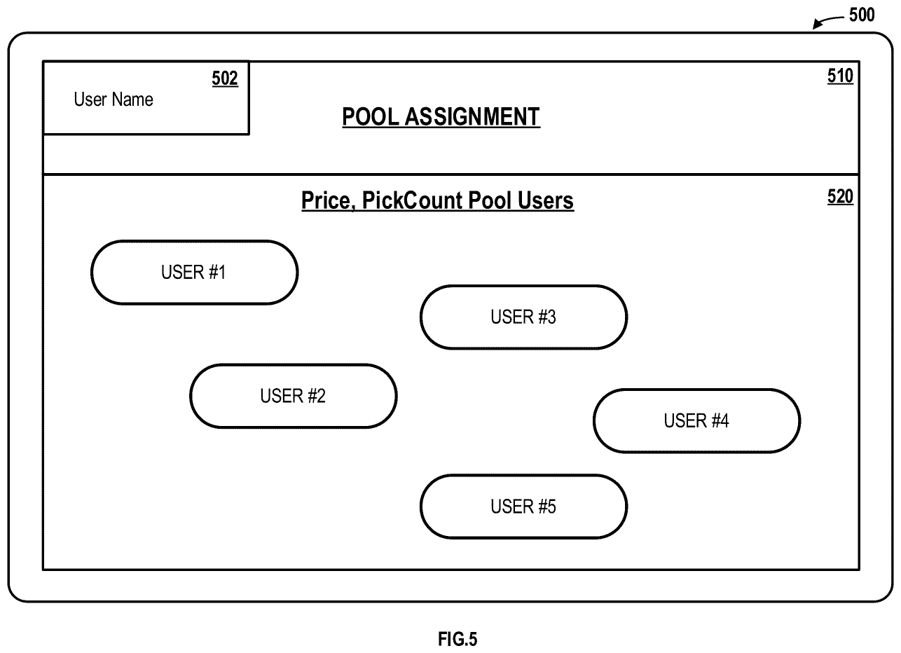

FIG. 5 shows an example user interface 500 configured to display one or more users of the group of users the user is assigned to, such as after the user has made price and pick count selections via a main menu of application 104 via the user device 102. The user may be provided with a pool assignment 510 user interface which may identify the signed-in 502 user and the users 520 that have been included, or are being included, in the group of users associated with the user. For example, the user may be associated with, or placed in, a group of users comprising users that selected the same price and pick count.

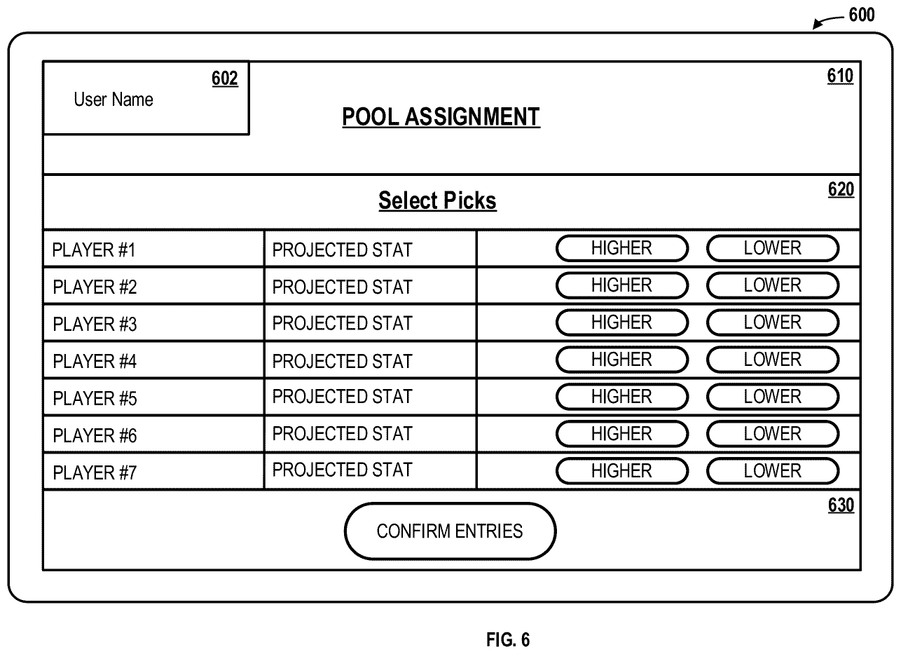

FIG. 6 shows an example user interface 600 configured to display one or more events available to the user in order to make predictions associated with each event. The user may be provided with a pool assignment 610 user interface which may identify the signed-in 602 user. As an example, the user may select a daily, a rolling weekly, and/or a season long gaming session. In an example, the user may select a gaming session associated with a daily pool wherein the user may select from a plurality of events associated with events that will go final, or conclude, on the same calendar date. In another example, the user may select a gaming session associated with a weekly pool wherein the user may select from a plurality of events associated with events that will conclude within the next several days (e.g., 5 days, 7 days, etc.). In another example, the user may select a gaming session associated with a season long pool wherein the user may select from a plurality of events that occur over a single season for a single sport (e.g., basketball, baseball, football, etc.). The user may provide a prediction for each event of the plurality of events 620, up to the selected pick count (e.g., amount of events). The user may select the initial predicted outcome of each event up to the selected amount of events or provide an alternative prediction (e.g., higher or lower than the initial predicted outcome) for each event up to the selected amount of events. For example, the user may provide five predictions based on a pick count selection of 5 events (e.g., pick 5). For example, the user may provide a first prediction for a first player associated with a first sports event, a second prediction for a second player associated with a second sports event, a third prediction for a third player associated with a third sports event, a fourth prediction for a fourth player associated with a fourth sports event, and a fifth prediction for a fifth player associated with a fifth sports event. Once the user has made the selections, the user may confirm the entries 630.

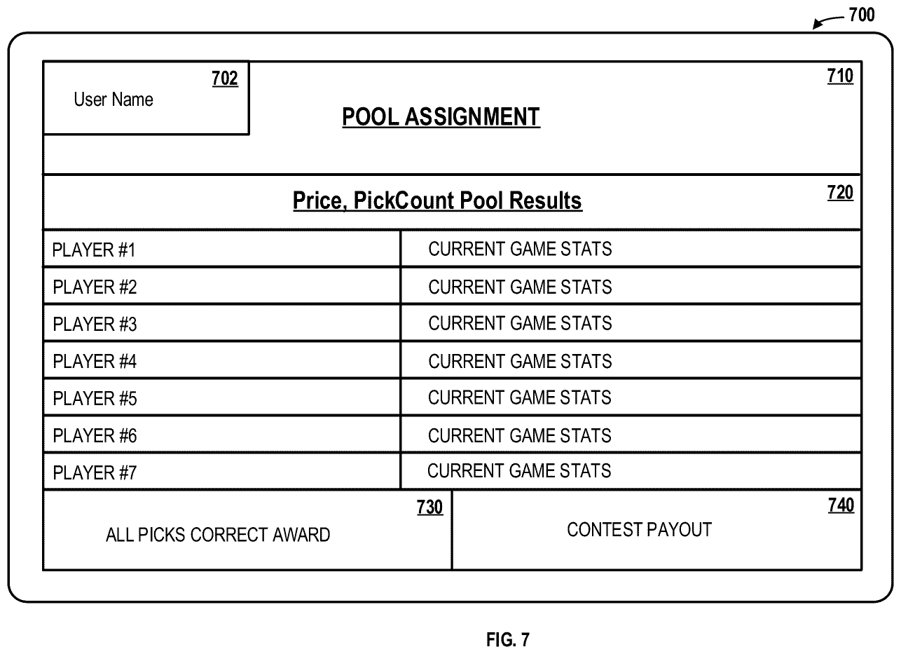

FIG. 7 shows an example user interface 700 configured to display results associated with the user's gaming session. The user may be provided with a pool assignment 710 user interface which may identify the signed-in 702 user. The results 720 of each event (e.g., player statistics) may be displayed (e.g., in real-time or live results) as the games are played out. The results 720 may be finalized as each sports event associated with each event concludes. In addition, the all picks correct award 730 and the contest (e.g., gaming session) payout 740 may be displayed for the corresponding gaming session.

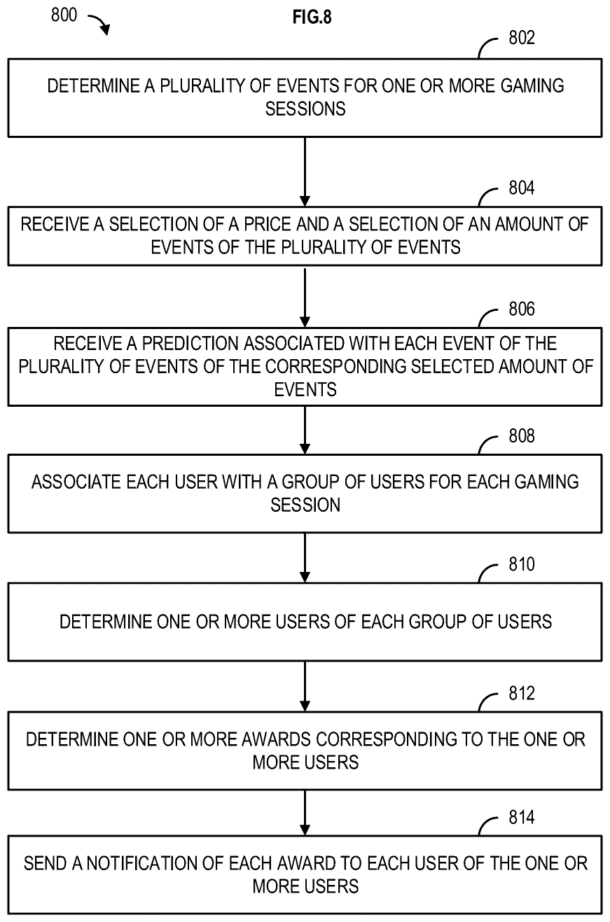

FIG. 8 shows a flowchart of an example method 800 for generating one or more gaming sessions (e.g., pool competition) based on a plurality of users. Method 800 may be implemented by a computing device (e.g., backend platform device 101, servers 106, etc.). At step 802, a plurality of events for one or more gaming sessions may be determined. For example, the computing device (e.g., backend platform device 101, servers 106, etc.) may determine the plurality of events for the one or more gaming sessions. Each event of the plurality of events may comprise a predicted outcome associated with a player statistic associated with a sports event. In an example, each event may be associated with a time duration for settling. For example, since each event comprises player statistics during a sports event/game, the final statistics would not finalize/settle until the end of the sports event/game.

At step 804, a selection of a price and a selection of an amount of events of the plurality of events may be received from each user device of a plurality of user devices. For example, the computing device (e.g., backend platform device 101, servers 106, etc.) may receive the selection of the price and the selection of the amount of events from each user device of the plurality of user devices. As an example, the user may select from one or more prices (e.g., entry fees, pick prices), such as $5, $20, and $50, and one or more amount of events (e.g., pick counts), such as Pick 2, Pick 4, and Pick 5. The amount of events may comprise at least two events. Each user device may be associated with a user.

At step 806, a prediction associated with each event of the plurality of events associated with the corresponding selected amount of events may be received from each user device. For example, the computing device (e.g., backend platform device 101, servers 106, etc.) may receive the prediction associated with each event of the plurality of events associated with the corresponding selected amount of events from each user device. For example, a user may provide five predictions based on a selection of 5 events (e.g., pick 5). For example, the user may provide a first prediction for a first player associated with a first sports event, a second prediction for a second player associated with a second sports event, a third prediction for a third player associated with a third sports event, a fourth prediction for a fourth player associated with a fourth sports event, and a fifth prediction for a fifth player associated with a fifth sports event.

At step 808, each user may be associated with a group of users for each gaming session of the one or more gaming sessions based on the corresponding selected price received from each user device and the corresponding selected amount of events received from each user device. For example, the computing device (e.g., backend platform device 101, servers 106, etc.) may associate each user with the group of users for each gaming session of the one or more gaming sessions based on the corresponding selected price received from each user device and the corresponding selected amount of events received from each user device. In an example, one or more users of the plurality of users may be determined to be associated with a selection of one or more of a push, a tie, or a void. Each user may be further associated with a group of users for each gaming session based on the corresponding selection associated with the one or more of the push, the tie, or the void.

In an example, each group of users may comprise a predetermined amount of users (e.g., 10, 20, 50, 80, 100, etc.). For example, each group of users may be filled with new users that selected the same price and pick count until reaching the predetermined amount of users for that group of users. Afterwards, a new group of users for that price and pick count may be created and new users may be added to the new group of users until it reaches the predetermined amount of users. For example, if a pick 5, $5 group of users has a maximum amount of users of 100 users, users that selected a pick count of 5 and a pick price of $5 will be added to the group of users until it reaches 100 users. Afterwards, a new pick 5, $5 group of users may be created and new users that selected a pick count of 5 and a pick price of $5 will be added to the new group of users.

In an example, each user may be associated with a group of users based on the time duration associated with each event for settling. For example, each user would not be grouped into a group of users until every event for that user settles. For example, if a user selected a pick count of Pick 5 and a pick price of $20 the user would not be placed into a group associated with a Pick 5 pick count and $20 pick price until every event associated with the user's selection/entry finalized (e.g., the associated sports event is completed or ends). For example, the user would be placed in the group when the final statistics for each event associated with the user finalizes/settles after the end of the longest duration of the events associated with that user.

At step 810, one or more users of each group of users associated with an amount of correct predictions of the corresponding predictions associated with each user that satisfies a condition may be determined. For example, the computing device (e.g., backend platform device 101, servers 106, etc.) may determine the one or more users of each group of users associated with the amount of correct predictions of the corresponding predictions associated with each user that satisfies the condition. The condition may comprise one or more of a determination that all predictions received from a user are correct, or a determination that at least one prediction received from a user is correct and no other user in the corresponding group of users associated with the user has a number of predictions greater than the user.

At step 812, one or more awards corresponding to the one or more users may be determined based on the satisfied condition. For example, the one or more awards corresponding to the one or more users may be determined by the computing device (e.g., backend platform device 101, servers 106, etc.) based on the satisfied condition. For example, the one or more awards may comprise one of a first award based on a determination that all predictions received from a user are correct, or a second award based on a determination that at least one prediction received from a user is correct and no other user in the corresponding group of users associated with the user has a number of predictions greater than the user.

At step 814, a notification of each award may be sent to each user of the one or more

users. For example, the computing device (e.g., backend platform device 101, servers 106, etc.) may send the notification of each award to each user of the one or more users. The notification may comprise one or more of a text message, a push notification, or an email message. In an example, each award of the one or more awards may be sent to each user of the one or more users.

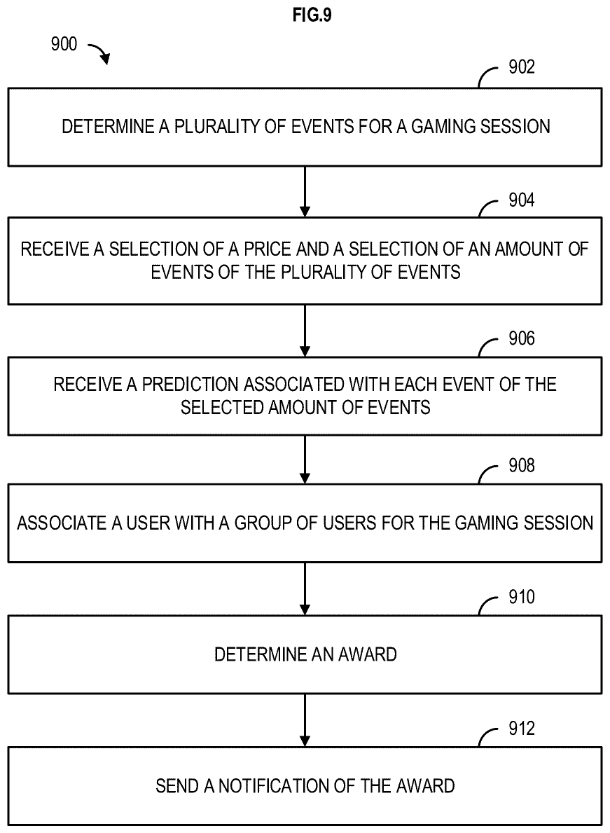

FIG. 9 shows a flowchart of an example method 900 for generating a gaming session (e.g., pool competition) for a user. Method 900 may be implemented by a computing device (e.g., backend platform device 101, servers 106, etc.). At step 902, a plurality of events for a gaming session may be determined. For example, the plurality of events for the gaming session may be determine by the computing device (e.g., backend platform device 101, servers 106, etc.). Each event of the plurality of events may comprise a predicted outcome associated with a player statistic associated with a sports event. In an example, each event may be associated with a time duration for settling. For example, since each event comprises player statistics during a sports event, the final statistics for the player would not finalize/settle until the end of the sports event.

At step 904, a selection of a price and a selection of an amount of events of the plurality of events may be received from a user device associated with a user. For example, the selection of the price and the selection of the amount of events may be received from the user device by the computing device (e.g., backend platform device 101, servers 106, etc.). As an example, the user may select from one or more prices (e.g., entry fees, pick prices), such as $5, $20, and $50, and one or more amount of events (e.g., pick counts), such as Pick 2, Pick 4, and Pick 5. The amount of events may comprise at least two events.

At step 906, a prediction associated with each event of the plurality of events associated with the selected amount of events may be received. For example, the prediction associated with each event of the plurality of events associated with the selected amount of events may be received by the computing device (e.g., backend platform device 101, servers 106, etc.). For example, a user may provide five predictions based on a selection of 5 events (e.g., pick 5). For example, the user may provide a first prediction for a first player associated with a first sports event, a second prediction for a second player associated with a second sports event, a third prediction for a third player associated with a third sports event, a fourth prediction for a fourth player associated with a fourth sports event, and a fifth prediction for a fifth player associated with a fifth sports event.

At step 908, the user may be associated with a group of users for the gaming session based on the selected price and the selected amount of events. For example, the computing device (e.g., backend platform device 101, servers 106, etc.) may associate the user with the group of users for the gaming session based on the selected price and the selected amount of events. The group of users may comprise a plurality of users associated with the selected amount of events and the selected price of a plurality of prices. In an example, each user of the group of users may be associated with a selection of price of $20 and a selection of an amount of 4 events.

In an example, the group of users may comprise a predetermined amount of users (e.g., 10, 20, 50, 80, 100, etc.). For example, the group of users may continue to be filled with new users that selected the same price and pick count until reaching the predetermined amount of users for the group of users. Afterwards, a new group of users for that price and pick count may be created and new users may be added to the new group of users until it reaches the predetermined amount of users. For example, if a pick 5, $5 group of users has a maximum amount of users of 100, users that selected a pick count of 5 and a pick price of $5 will be added to the group of users until it reaches 100 users. Afterwards, a new pick 5, $5 group of users may be created and new users that selected a pick count of 5 and a pick price of $5 will be added to the new group of users. As an example, if the group of users is filled with the predetermined amount of users before the user is added to the group of users, the user may be added to the next new group of users associated with the selected price and selected amount of events.

In an example, the user may be associated with the group of users based on the time duration associated with each event for settling. For example, each user would not be grouped into a group of users until every event for that user settles. For example, if a user selected a pick count of Pick 5 and a pick price of $20 the user would not be placed into a group associated with a Pick 5 pick count and $20 pick price until every event associated with the user's selection/entry finalized (e.g., the associated sports event is completed or ends). For example, the user would be placed in the group when the final statistics for each event associated with the user finalizes/settles after the end of the longest duration of the events associated with that user.

At step 910, an award may be determined based on an amount of correct predictions of the predictions associated with the selected amount of events satisfying a condition. For example, the computing device (e.g., backend platform device 101, servers 106, etc.) may determine the award based on the amount of correct predictions of the predictions associated with the selected amount of events satisfying the condition. The condition may comprise one or more of a determination that all of the predictions received from the user are correct, or a determination that at least one prediction received from the user and no other user in the group of users has a number of predictions greater than the user. In an example, the award may be determined after a longest duration of each time duration associated with each event.

At step 912, a notification of the award may be sent to the user. For example, the computing device (e.g., backend platform device 101, servers 106, etc.) may send the notification of the award to the user (e.g., the user device). The notification may comprise one or more of a text message, a push notification, or an email message. In an example, the award may be sent to the user (e.g., user device).

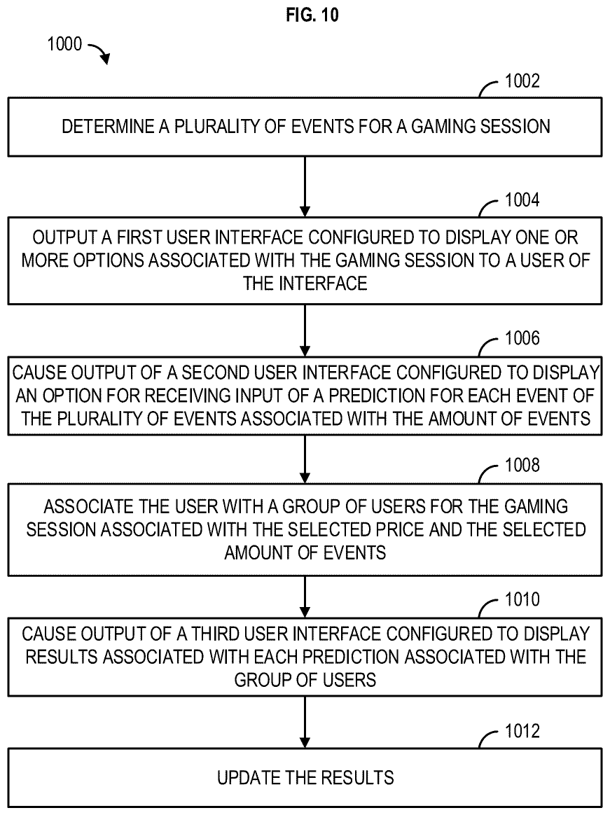

FIG. 10 shows a flowchart of an example method 1000 for generating one or more user interfaces associated with a gaming session (e.g., pool competition). Method 1000 may be implemented by a user device (e.g., user device 102). At step 1002, a plurality of events for a gaming session may be determined. For example, the plurality of events for the gaming session may be determined by the user device (e.g., user device 102). Each event of the plurality of events may comprise a predicted outcome associated with a player statistic associated with a sports event.

At step 1004, a first user interface may be output to a user by the user device (e.g., user device 102). In an example, the first user interface may be output via an application (e.g., application 104) of the user device. The application may comprise a mobile application or a web browser. The application may be configured to cause the user device to output the one or more options for the gaming session. The first user interface may be configured to display one or more options associated with the gaming session to a user of the user device. The one or more options may comprise one or more of one or more prices or one or more amount of events of the plurality of events. In an example, the first user interface may be output based on a location of the user device.

At step 1006, a second user interface may be output to the user by the user device (e.g., user device 102) based on a selection of a price of the one or more prices and based on a selection of an amount of events of the one or more amount of events. In an example, the second user interface may be output via the application (e.g., application 104) of the user device. The second user interface may be configured to display an option for receiving input of a prediction for each event of the plurality of events of the amount of events. For example, the user may select the initial predicted outcome of each event or provide an alternative prediction (e.g., higher or lower than the initial predicted outcome) for each event.

At step 1008, the user may be associated with a group of users for the gaming session associated with the selected price and the selected amount of events. For example, the user device (e.g., user device 102) may associate the user with the group of users for the gaming session associated with the selected price and the selected amount of events. The group of users may comprise a plurality of users associated with the selected amount of events and the selected price. For example, each user of the group of users may be associated with a selection of price of $100 and a selection of an amount of 5 events.

In an example, the group of users may comprise a predetermined amount of users (e.g., 10, 20, 50, 80, 100, etc.). For example, the group of users may continue to be filled with new users that selected the same price and pick count until the group of users reaches the predetermined amount of users for the group of users. Afterwards, a new group of users for that price and pick count may be created and new users may be added to the new group of user until it reaches the predetermined amount of users. For example, if a pick 3, $20 group of users has a maximum amount of users of 50, users that selected a pick count of 3 and a pick price of $20 will be added to the group of users until it reaches 50 users. Afterwards, a new pick 3, $20 group of users may be created and new users that selected a pick count of 3 and a pick price of $20 will be added to the new group of users. As an example, if the group of users is filled with the predetermined amount of users before the user is added to the group of users, the user may be added to the next new group of users associated with the selected price and selected amount of events.

In an example, the user may be associated with the group of users based on the time duration associated with each event for settling. For example, each user would not be grouped into a group of users until every event for that user settles. For example, if a user selected a pick count of Pick 5 and a pick price of $20 the user would not be placed into a group associated with a Pick 5 pick count and $20 pick price until every event associated with the user's selection/entry finalized (e.g., the associated sports event is completed or ends). For example, the user would be placed in the group when the final statistics for each event associated with the user finalizes/settles after the end of the longest duration of the events associated with that user.

At step 1010, a third user interface may be output to the user by the user device (e.g., user device 102) based on an input of a prediction for each event of the amount of events. In an example, the third user interface may be output via the application (e.g., application 104) of the user device. The third user interface may be configured to display results associated with each prediction associated with the group of users. For example, as the games of each event progresses, the player statistics associated with each game may be updated and the results associated with the user's predictions may be updated accordingly. In an example, an all picks correct award may be updated based on users that currently have all correct predictions. In an example, if none of the users in the group of users have all correct predictions, the award may be updated to reflect the updated award based on the users with the current highest amount of correct predictions.

At 1012, the results may be updated based on a number of correct predictions of the selected amount of events. In an example, it may be determined that the number of correct predictions of the selected amount of events satisfies a condition. The condition may comprise one of no correct predictions of the selected amount of events, all of the predictions are correct and all user entries of the group of users are final, all of the predictions are correct and all user entries of the group of users are not final, or at least one prediction is correct and no other user in the group of users has a greater number of correct predictions. The awards may be updated based on the satisfied condition. In an example, based on the condition of no correct predictions of the selected amount of events, the updated results may comprise one or more of an indication of a loss, each correct prediction of the selected amount of events, or each incorrect prediction of the selected amount of events. In an example, based on the condition of all of the predictions are correct and all user entries of the group of users are final, the updated results may comprise one or more of predictions associated with each user of the group of users, an award amount, a portion of the award amount associated with the user, an amount of users of the group of users with all correct predictions, or one or more names of experienced users of the group of users. In an example, based on the condition of all of the predictions are correct and all user entries of the group of users are not final, the updated results may comprise one or more of predictions associated with each user of the group of users, an award amount associated with a winner of the group of users, an amount of users of the group of users with all correct predictions, an award amount associated with all correct predictions, or a pending state associated with a potential portion of the award amount associated with the user. In an example, based on the condition of at least one prediction is correct and no other user in the group of users has a greater number of correct predictions, the updated results may comprise one or more of an amount of correct predictions or an award amount.

The methods and systems can employ artificial intelligence (AI) techniques such as machine learning and iterative learning. Examples of such techniques comprise, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, such as: matters of logic with respect to arrangement of steps or operational flow; plain meaning derived from grammatical organization or punctuation; the number or type of embodiments described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as examples only, with a true scope and spirit being indicated by the following claims.

What is claimed is:

1. A method comprising:
determining, by a computing device, a plurality of events for one or more gaming sessions;
receiving, from each user device of a plurality of user devices, a selection of a price and a selection of an amount of events of the plurality of events, wherein each user device is associated with a user;
receiving, from each user device, a prediction associated with each event of the plurality of events associated with the corresponding selected amount of events;
associating, based on the corresponding selected price received from each user device and the corresponding selected amount of events received from each user device, each user with a group of users for each gaming session of the one or more gaming sessions;
determining one or more users of each group of users associated with an amount of correct predictions of the corresponding predictions associated with each user that satisfies a condition;
determining, based on the satisfied condition, one or more awards corresponding to the one or more users; and
sending a notification of each award to each user of the one or more users.

2. The method of claim 1, wherein each event of the plurality of events comprises a predicted outcome associated with a player statistic associated with a sports event.

3. The method of claim 1, wherein each group of users comprises a plurality users associated with an amount of events of the plurality of events and a price of a plurality of prices.

4. The method of claim 1, wherein each event of the plurality of events is associated with a time duration for each event to settle, wherein the time duration for each event to settle is based on when a corresponding sports event for each event is completed, and wherein associating each user with a group of users for each gaming session comprises associating each user with a group of users for each gaming session based on the time duration for each event associated with each corresponding user to settle.

5. The method of claim 1, wherein the condition comprises one or more of a determination that all predictions received from a user are correct, or a determination that at least one prediction received from a user is correct and no other user in the corresponding group of users associated with the user has a number of predictions greater than the user.

6. The method of claim 1, wherein the one or more awards comprise one of:
a first award based on a determination that all predictions received from a user are correct, or
a second award based on a determination that at least one prediction received from a user is correct and no other user in the corresponding group of users associated with the user has a number of predictions greater than the user.

7. A method comprising:
determining, by a computing device, a plurality of events for a gaming session;
receiving, from a user device associated with a user, a selection of a price and a selection of an amount of events of the plurality of events;
receiving a prediction associated with each event of the plurality of events associated with the selected amount of events;
associating, based on the selected price and the selected amount of events, the user with a group of users for the gaming session;
determining, based on an amount of correct predictions of the predictions associated with the selected amount of events satisfying a condition, an award; and
sending a notification of the award to the user.

8. The method of claim 7, wherein each event of the plurality of events comprises a predicted outcome associated with a player statistic associated with a sports event.

9. The method of claim 7, wherein the group of users comprises a plurality of users associated with the selected amount of events and the selected price of a plurality of prices.

10. The method of claim 7, wherein each event of the plurality of events is associated with a time duration for each event to settle, wherein the time duration for each event to settle is based on when a corresponding sports event for each event is completed, and wherein associating the user with the group of users for the gaming session comprises associating the user with the group of users for the gaming session based on the time duration for each event associated with the user to settle.

11. The method of claim 7, wherein the condition comprises one or more of a determination that all of the predictions received from the user are correct, or a determination that at least one prediction received from the user and no other user in the group of users has a number of predictions greater than the user.

12. The method of claim 7, wherein the award comprises one or more of:
a first award based on a determination that all predictions received from the user are correct, or
a second award based on a determination that at least one prediction received from the user and no other user in the group of users has a number of predictions greater than the user.

13. A method comprising:
determining, by a user device, a plurality of events for a gaming session;
outputting a first user interface configured to display one or more options associated with the gaming session to a user of the user device, wherein the one or more options comprise one or more of one or more prices or one or more amount of events of the plurality of events;
causing, based on a selection of a price of the one or more prices and based on a selection of an amount of events of the one or more amount of events, output of a second user interface configured to display an option for receiving input of a prediction for each event of the plurality of events associated with the amount of events;
associating the user with a group of users for the gaming session associated with the selected price and the selected amount of events;
causing, based on an input of a prediction for each event of the amount of events, output of a third user interface configured to display results associated with each prediction associated with the group of users; and
updating, based on a number of correct predictions of the selected amount of events, the results.

14. The method of claim 13, wherein each event of the plurality of events comprises a predicted outcome associated with a player statistic associated with a sports event.

15. The method of claim 13, further comprising determining the number of correct predictions of the selected amount of events satisfies a condition, wherein the condition comprises one of no correct predictions of the selected amount of events, all of the predictions are correct and all user entries of the group of users are final, all of the predictions are correct and all user entries of the group of users are not final, or at least one prediction is correct and no other user in the group of users has a greater number of correct predictions.

16. The method of claim 15, wherein updating the results comprises updating, based on the satisfied condition, the results.

17. The method of claim 16, wherein, based on the condition of no correct predictions of the selected amount of events, the updated results comprises one or more of an indication of a loss, each correct prediction of the selected amount of events, or each incorrect prediction of the selected amount of events.

18. The method of claim 16, wherein, based on the condition of all of the predictions are correct and all user entries of the group of users are final, the updated results comprises one or more of predictions associated with each user of the group of users, an award amount, a portion of the award amount associated with the user, an amount of users of the group of users with all correct predictions, or one or more names of experienced users of the group of users.

19. The method of claim 16, wherein, based on the condition of all of the predictions are correct and all user entries of the group of users are not final, the updated results comprises one or more of predictions associated with each user of the group of users, an award amount associated with a winner of the group of users, an amount of users of the group of users with all correct predictions, an award amount associated with all correct predictions, or a pending state associated with a potential portion of the award amount associated with the user.

20. The method of claim 16, wherein, based on the condition of at least one prediction is correct and no other user in the group of users has a greater number of correct predictions, the updated results comprises one or more of an amount of correct predictions, an award amount.
